(19) United States
(12) Patent Application Publication
(10) Pub. No.: US 2012/0325725 A1
(43) Pub. Date: Dec. 27, 2012

(54) Flotation Reagent For Iron Ores Containing Magnetite And/Or Haematite

(75) Inventors: Klaus-Ulrich Pedain, Dietzenbach-Steinberg (DE); Uwe Dahlmann, Mainz (DE)

(73) Assignee: CLARIANT FINANCE (BVI) LIMITED, Tortola (VG)

(21) Appl. No.: 13/521,546

(22) PCT Filed: Jan. 4, 2011
(86) PCT No.: PCT/EP2011/000007

§ 371 Date: Jul. 11, 2012

(30) Foreign Application Priority Data
Jan. 19, 2010 (DE) 10 2010 004 893.3

(51) Int. Cl. B03D 1/01; B03D 103/04

(52) U.S. Cl. 209/4

(57) ABSTRACT

The present invention relates to a flotation reagent for iron ores containing magnetite and/or haematite and to the use of a composition containing A) at least one amine alkoxylate ester of formula (I) or a salt thereof,

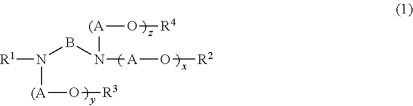

wherein A and B, independently of one another, represent a C₂-C₅ alkylene radical, R¹ is a C₈ to C₂₄ alkyl or alkenyl radical, R², R³ and R⁴, independently of one another, are H or a C₈ to C₂₄ acyl radical, with the proviso that at least one of the radicals R², R³ or R⁴ stands for a C₈ to C₂₄ acyl radical, x, y and z, independently of one other, are an integer of from 0 to 50, with the proviso that x+y+z is an integer of from 1 to 100, and B) a compound of formula D-NH₂, in which D stands for a hydrocarbon radical having from 1 to 50 carbon atoms, which can contain either an oxygen atom or an oxygen atom and a nitrogen atom, in amounts of 10 to 5.000 g/tonne as a collector in the reverse flotation of iron ore containing magnetite, haematite or both.

The present invention relates to the use of collectors in the beneficiation by flotation of iron ore that contains magnetite and/or hematite.

Many naturally occurring ores and minerals contain silicate as an unwanted accompanying mineral. In addition to iron ore, these include calcite, phosphate ore and feldspar. In particular in the case of iron ore, the silicate content reduces the quality of the iron ore and interferes in the production of iron. In order to obtain high-quality iron ore, it is of interest to lower the silicate content of the iron ore to below 2%. Usually, the iron ore is separated from the silicate not only by magnetic separation, but also by reverse flotation. For this purpose, the ground iron ore is combined in a flotation cell with water and flotation reagents, wherein the silicate is discharged together with the froth by the use of a collector, while the iron ore remains behind in what is termed the pulp.

Silicate collectors which are used are, for example, fatty amines, alkyl ether amines and alkyl ether diamines. These are known under the trade name Flotigam®.

Alkyl ether amines and alkyl ether diamines are chiefly used in their partially neutralized forms as partial acetates, as described in U.S. Pat. No. 4,319,987. The reason therefor is the better solubility thereof in the pulp.

U.S. Pat. No. 6,076,682 describes the combined use of alkyl ether monoamine with alkyl ether diamine for silicate flotation from iron ore.

In WO 00/62937, the use of quaternary amines for flotation of iron ore is disclosed.

In WO-93/06935, the synergistic action of ether amines and anionic collectors for iron ore flotation is described.

Silicate flotation, inter alia from iron ore, using alkyloxyalkanamines is described in U.S. Pat. No. 5,540,337.

DE-A-10 2006 010 939 discloses the use of a compound of the formula (I)

R¹—O—R²—NH₍₂₋ₘ₎—[(R³)ₙ—H]ₘ (I)

where R¹ is a hydrocarbon group having 1-40 carbon atoms, R² is an aliphatic hydrocarbon group having 2-4 carbon atoms, and R³ is an alkoxy group, n is a number between 1 and 50, and m is 1 or 2, as flotation reagent in silicate flotation.

The collectors known in the prior art for iron ore flotation have inadequate selectivity and yield, in particular when iron ores which contain magnetite and/or hematite are to be separated from silicates as accompanying mineral.

It was therefore the object of the present invention to find an improved collector for reverse iron ore flotation which floats silicates more selectively.

The present invention therefore relates to the use of a composition comprising

A) at least one amine alkoxylate ester of the formula (I) or a salt thereof

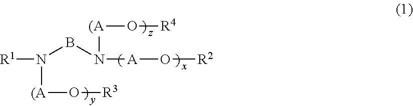

where
A, B independently of one another are a C₂ to C₅ alkylene radical
R¹ is a C₈ to C₂₄ alkyl or alkenyl radical
R², R³, R⁴ independently of one another are H or a C₈ to C₂₄ acyl radical, with the proviso that at least one of the radicals R², R³ or R⁴ is a C₈ to C₂₄ acyl radical
x, y, z independently of one another are an integer from 0 to 50, with the proviso that x+y+z is an integer from 1 to 100,
   and
   B) a compound of the formula D-NH₂, where D is a hydrocarbon radical having 1 to 50 carbon atoms and which can contain either an oxygen atom or an oxygen atom and a nitrogen atom,
   in amounts of 10 to 5000 g/tonne as collector in the reverse flotation of iron ore which contains magnetite, hematite, or both.

The invention further relates to a method for the reverse flotation of iron ore that comprises magnetite, hematite or both, by contacting the iron ore with a composition comprising

A) at least one amine alkoxylate ester of the formula (I) or a salt thereof

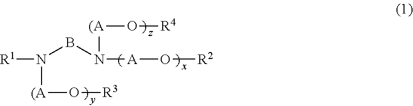

where
A, B independently of one another are a C₂ to C₅ alkylene radical
R¹ is a C₈ to C₂₄ alkyl or alkenyl radical
R², R³, R⁴ independently of one another are H or a C₈ to C₂₄ acyl radical, with the proviso that at least one of the radicals R², R³ or R⁴ is a C₈ to C₂₄ acyl radical
x, y, z independently of one another are an integer from 0 to 50, with the proviso that x+y+z is an integer from 1 to 100,
   and
   B) a compound of the formula D-NH₂, where D is a hydrocarbon radical having 1 to 50 carbon atoms and which can contain either an oxygen atom or an oxygen atom and a nitrogen atom,
   in amounts of 10 to 5000 g/tonne of iron ore.

The composition of A) and B) is hereinafter also termed “collector according to the invention”.

A) and/or B) can be used as described or in the form of salts thereof which are obtainable by reacting A) and/or B) with acids, for example acetic acid or hydrochloric acid.

The ratio of the collector components A:B is preferably between 98:2 and 2:98 by weight, in particular between 70:30 and 30:70 by weight.

In a particularly preferred embodiment, the collector according to the invention is free from quaternary ammonium compounds that comprise at least one organic radical that is bound to the ammonium nitrogen atom, optionally contains heteroatoms, and has 8 to 36 carbon atoms. A quaternary ammonium compound is taken to mean a compound which does not bear a hydrogen atom on the ammonium nitrogen atom, but in which the ammonium nitrogen atom is bound to four carbon atoms. This particularly preferred embodiment is therefore not taken to mean the embodiment in which either the compound of the formula 1 or the compound B) of the formula D-NH₂ or both are present as mono- or diammonium salts. These mono- or diammonium salts bear at least one hydrogen atom on the ammonium nitrogen atom.

Component B) can also be used as salt, for example as acetate. Component B) of the collector according to the invention is preferably one or more of the compounds of the formulae (II) to (IV).

These compounds are

R⁹—O—R⁵—NH₂ (II)

where R⁹ is a hydrocarbon group having 1-40, preferably 8-32, carbon atoms and R⁵ is an aliphatic hydrocarbon group having 2-4 carbon atoms;

R⁶—O—R⁷—NH—R⁸—NH₂ (III)

where R⁶ is a hydrocarbon group having 1-40, preferably 8-32, carbon atoms, R⁷ and R⁸ are an aliphatic hydrocarbon group or different aliphatic hydrocarbon groups having 2-4 carbon atoms;

R¹³—NH₂ (IV)

where R¹³ is a hydrocarbon group having 1-40, preferably 8-32, carbon atoms.

R¹ is preferably a linear or branched alkyl or alkenyl group which comprises 10 to 22 carbon atoms. Particularly preferably, R¹ are isodecyl, isotridecyl, dodecyl, coconut fatty alkyl, or tallow fatty alkyl radicals. R¹, in a preferred embodiment, is an alkyl and alkenyl chain section which is derived from coconut oil fatty acid, palm oil fatty acid, tallow fatty acid, oleic acid, tall oil fatty acid or rapeseed oil fatty acid.

R², R³, R⁴ independently of one another are acyl radicals having 8 to 24 carbon atoms. The acyl radicals preferably comprise 10 to 18 carbon atoms. They can be linear or branched. The acyl radicals can be saturated or unsaturated. Preferred acyl radicals are stearoyl and oleoyl radicals.

R⁶, R⁹, R¹³, independently of one another, are preferably a linear or branched alkyl or alkenyl group which 8 to 18 carbon atoms. Particularly preferably, R⁶, R⁹, R¹³ are 2-ethylhexyl, isononyl, isodecyl and isotridecyl and dodecyl radicals.

R⁵, R⁷, R⁸, independently of one another, are preferably alkylene groups having 2, 3 or 4 carbon atoms, in particular ethylene or propylene groups.

A, in particular, is either an ethylene(—C₂H₄—) group, a propylene(—C₃H₆—) group or a butylene(—C₄H₈—) group. Preferably, A is an ethylene group.

B, in particular, is either an ethylene(—C₂H₄—) group, a propylene(—C₃H₆—) group or a butylene(—C₄H₈—) group. Preferably, B is an isopropylene group.

The sum of x, y and z preferably gives an integer from 15 to 30, in particular 20 to 25.

In a preferred embodiment, the amino alkoxylate ester which makes up the component A) is present in the form of the mono- or diammonium salts thereof which are obtained by neutralization either with organic or mineral acids.

The use of the flotation reagent according to the invention can also proceed in combination with frothers and depressants, as are known from the prior art. In order to avoid iron ore being co-discharged in the reverse flotation, preferably hydrophilic polysaccharides, such as, for example, modified starch, carboxymethylcellulose, or gum arabic, are added as depressants in dosages of 10 to 1000 g/t.

Silicate flotation is preferably carried out at a pH of 7-12, in particular 8-11, which is adjusted, for example, using sodium hydroxide.

### EXAMPLES

The table hereinafter presents the flotation results of the collector according to the invention in comparison with the standard reagent. Flotation experiments were carried out on an iron ore which contained magnetite and hematite.

### A) Composition of the Iron Ore

| | |
|---|---|
| Magnetite | 59% by weight |
| Hematite | 25% by weight |
| (other components) | 16% by weight |

### B) Composition of the Collectors

### Collector 1 (Comparison)

C₁₀ alkyloxypropylamine acetate of the formula (II), wherein R⁹ is a decyl group and R⁵ is a propyl group.

### Collector 2 (Comparison)

Mixture of dicoconut alkyldimethylammonium chloride and ethoxylated coconut alkylpropylenediamine, esterified with oleic acid (corresponding to formula I where A=ethylene, B=propylene, R¹=coconut fatty alkyl, R², R³, R⁴=oleoyl, the total of x, y, z is 50) in the weight ratio 1:1.

### Collector 3 (Comparison)

C₁₀ alkyloxydipropylenediamine acetate of the formula (III), wherein R⁶ is a decyl group, R⁷ and R⁸ are a propyl group.

### Collector 4 (According to the Invention)

Mixture of 50% by weight of a compound of the formula 1, where

A=ethylene
B=propylene
R¹=coconut fatty alkyl
R²=oleoyl
R³=oleoyl and
R⁴=oleoyl
the sum of x, y, z is 50, and 50% by weight C₁₀ alkyloxypropylamine acetate of the formula (II), wherein R⁹ is a decyl group and R⁵ is a propyl group.

### Collector 5 (Comparison)

Mixture of 20% by weight dicoconut alkyldimethylammonium chloride, 30% by weight C₁₀ alkyoxydipropylenediamine of the formula (III), wherein R⁶ is a decyl group, R⁷ and R⁸ are a propyl group and 50% by weight ethoxylated coconut alkylpropylenediamine, esterified with oleic acid (corresponding to formula I where A=ethylene, B=propylene, R¹=coconut fatty alkyl, R², R³, R⁴=oleoyl, the sum of x, y, z is 50).

TABLE 1
Effectiveness of the collector according to the invention
compared with the prior art

| | | Dosage | Yield of Fe | Content of Fe |
|---|---|---|---|---|
| Example | Collector | [g/t] | [%] | [%] |
| 1 (C) | 1 | 70 | 86.5 | 66.8 |
| 2 (C) | 1 | 80 | 84.6 | 67.5 |
| 3 (C) | 1 | 90 | 82.1 | 68 |
| 4 (C) | 2 | 70 | 86.4 | 67.2 |
| 5 (C) | 2 | 80 | 84.3 | 67.8 |
| 6 (C) | 2 | 90 | 81.5 | 68.2 |
| 7 (C) | 3 | 70 | 85.7 | 67.6 |
| 8 (C) | 3 | 80 | 83.9 | 68.2 |
| 9 (C) | 3 | 90 | 82.1 | 68.5 |
| 10 | 4 | 70 | 86.8 | 67.5 |
| 11 | 4 | 80 | 84.9 | 68.3 |
| 12 | 4 | 90 | 81.9 | 68.8 |
| 13 (C) | 5 | 70 | 86.2 | 67.5 |
| 14 (C) | 5 | 80 | 84.6 | 68.1 |
| 15 (C) | 5 | 90 | 82.3 | 68.6 |

Yield of Fe = m(Fe in the concentrate)/m(Fe in the flotation feed) · 100%
m(Fe in the concentrate) = content of Fe in the concentrate · m(concentrate)/100%
m(Fe in the flotation feed) = content of Fe in the flotation feed · m(flotation feed)/100%

The content of Fe in the concentrate was determined by analysis.

1. A method for the reverse flotation of an iron ore that comprises magnetite, hematite or both, comprising the step of contacting the iron ore with a composition comprising
A) at least one amine alkoxylate ester of the formula (I) or a salt thereof 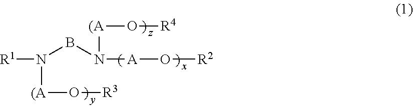
where
A, B independently of one another are a C₂ to C₅ alkylene radical
R¹ is a C₈ to C₂₄ alkyl or alkenyl radical
R², R³, R⁴ independently of one another are H or a C₈ to C₂₄ acyl radical, with the proviso that at least one of the radicals R², R³ or R⁴ is a C₈ to C₂₄ acyl radical
x, y, z independently of one another are an integer from 0 to 50, with the proviso that x+y+z is an integer from 1 to 100,
and
B) a compound of the formula D-NH₂, where D is a hydrocarbon radical having 1 to 50 carbon atoms and which can contain either an oxygen atom or an oxygen atom and a nitrogen atom,
in amounts of 10 to 5000 g/tonne of the iron ore.

2. The method as claimed in claim 1, wherein R¹ is an alkyl or alkenyl radical having 10 to 22 carbon atoms.

3. The method as claimed in claim 1, wherein R¹ is an isodecyl, isotridecyl, dodecyl or oleyl radical, or is an alkyl and alkenyl chain section which is derived from coconut oil fatty acid, palm oil fatty acid, tallow fatty acid, tall oil fatty acid or rapeseed oil fatty acid.

4. The method as claimed in claim 1, where R², R³, R⁴ independently of one another are acyl radicals having 10 to 18 carbon atoms.

5. The method as claimed in claim 1, where R², R³, R⁴ independently of one another are cocoyl, stearoyl and oleoyl radicals.

6. The method as claimed in claim 1, where component B is selected from the group consisting of compounds of the formulae
R⁹—O—R⁵—NH₂ (II)
where R⁹ is a hydrocarbon group having 1-40, carbon atoms and R⁵ is an aliphatic hydrocarbon group having 2-4 carbon atoms;
R⁶—O—R⁷—NH—R⁸—NH₂ (III)
where R⁶ is a hydrocarbon group having 1-40, carbon atoms, R⁷ and R⁸ are an aliphatic hydrocarbon group or different aliphatic hydrocarbon groups having 2-4 carbon atoms;
R¹³—NH₂ (IV)
where R¹³ is a hydrocarbon group having 1-40, carbon atoms.

7. The method as claimed in claim 1, where R⁶, R⁹, R¹³, independently of one another, are an alkyl or alkenyl group having 8 to 18 carbon atoms.

8. The method as claimed in claim 1, where R⁶, R⁹, R¹³ are 2-ethylhexyl, isononyl, isodecyl and isotridecyl and dodecyl radicals.

9. The method as claimed in claim 1, where A is an ethylene(—C₂H₄—) group, a propylene(—C₃H₆—) group or a butylene(—C₄H₈—) group.

10. The method as claimed in claim 1, where B is an ethylene(—C₂H₄—) group, a propylene(—C₃H₆—) group or a butylene(—C₄H₈—) group.

11. The method as claimed in claim 1, wherein the sum of x, y and z is an integer from 15 to 30.

12. The method as claimed in claim 1, where the composition is free from quaternary ammonium compounds that comprise at least one organic radical that is bound to the ammonium nitrogen atom, optionally contains heteroatoms, and has 8 to 36 carbon atoms.

13. The method as claimed in claim 1, for the flotation of silicate from iron ore further comprising at least one nitrogenous silicate collector at a pH of 7-12, where the nitrogenous silicate collector is selected from the group of alkyl ether amines, alkyl ether diamines, alkylamines, or quaternary ammonium salts.

14. The method as claimed in claim 1, for enrichment of iron ore.

15. The method as claimed in claim 1, in the flotation of silicate from iron ore, calcite, phosphate ore and feldspar.

16. The method as claimed in claim 1, in the flotation of silicate, wherein the ore comprises between 0 and 90% of silicate.

17. The method as claimed in claim 1, further comprising frothers and depressants.

18. The method as claimed in claim 1, in a pH range from 7 to 12.

19. The method as claimed in claim 1, wherein the composition is present in amounts of 0.001 to 1.0 kg per tonne of crude ore.

20. (canceled)

21. The method as claimed in claim 6, where R⁶ is a hydrocarbon group having 8-32, carbon atoms.

22. The method as claimed in claim 6, where R⁹ is a hydrocarbon group having 8-32, carbon atoms.

23. The method as claimed in claim 6, where R¹³ is a hydrocarbon group having 8-32, carbon atoms.

24. The method as claimed in claim 1, where A is an ethylene(—C₂H₄—) group.
